(19) United States
(12) Patent Application Publication
(10) Pub. No.: US 2010/0163724 A1
(43) Pub. Date: Jul. 1, 2010

(54) APPLICATIONS OF HYDROGEN GAS GETTERS IN MASS SPECTROMETRY

(75) Inventor: Guido Fridolin Verbeck, IV, Plano, TX (US)

Correspondence Address: CHALKER FLORES, LLP, 2711 LBJ FRWY, Suite 1036, DALLAS, TX, 75234, US

(73) Assignee: UNIVERSITY OF NORTH TEXAS, Denton, TX (US)

(21) Appl. No.: 12/649,907

(22) Filed: Dec. 30, 2009

Related U.S. Application Data
(60) Provisional application No. 61/141,546, filed on Dec. 30, 2008.

(51) Int. Cl. H01J 49/26; H01K 1/54

(52) U.S. Cl. 250/283; 96/17

(57) ABSTRACT

The present invention is an electrically controlled gettered pump assembly to entrain and fully release hydrogen gas to regulate the pressure and buffer the ions in an ion trap mass spectrometer and other portable analytical instruments. In addition to the gettered pump assembly, the present invention also incorporates a microvalve between the different chambers to release and control the hydrogen content. Hydrogen gas regulates the pressure in mass spectrometers and also acts as a buffering gas to prevent the ions from escaping the trap.

### CROSS-REFERENCE TO RELATED APPLICATIONS

This application claims benefit of U.S. Provisional applications Ser. No. 61/141,546 filed on Dec. 30, 2008, which are incorporated herein by reference in their entirety.

### TECHNICAL FIELD OF THE INVENTION

The present invention relates in general to the field of mass spectrometry, and more particularly, to using getter material saturated with hydrogen gas to regulate the pressure needed to run mass spectrometers, to buffer and thermalize the ions, and to prevent their escape from the ion trap.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Without limiting the scope of the invention, its background is described in connection with mass spectrometry particularly to the use hydrogen gas entrained in getters to regulate the pressure in mass spectrometers and as a buffering gas to prevent the ions from escaping the trap.

Getters typically refer to reactive materials used to remove traces of gas from vacuum systems. Gettering systems are prepared by arranging a reservoir of a volatile and reactive material inside a vacuum system; once the system is sealed, the material is heated, by induction heating causing it to evaporate and react with the residual gas. This causes self deposition on the walls leaving a silvery coating. If the tube is broken, the getter reacts with incoming air leaving a white deposit on the tube, and becomes useless; for this reason getters are not used in systems which are intended to be opened.

Lototsky, et al. (2005), have shown the application of reversible hydrogen getters in vacuum devices. Arc-melted ZrV alloy was used to modified by small amounts of oxygen as the getter material. Hydrogen sorption characteristics of the alloy were studied in the Sieverts-type setup. The hydrides were characterized by vacuum thermal desorption spectroscopy. X-ray diffraction was employed to study phase-structural composition of the getter and its hydride. The applications of the reversible hydrogen getters in vacuum-plasma devices were studied. The hydrogen getter material, located in the vacuum chamber of the installation, can be conveniently switched from its functions as the “internal” source of hydrogen supply to the mode of control over the hydrogen pressure by chemically “pumping” hydrogen from the volume into the getter. The energy of plasma particles bombarding the surface of the material allowed for controlling the supply of the plasma-forming gas (hydrogen). The authors also demonstrated a technology of the production of the MH elements for vacuum-plasma installations. The MH elements on the basis of the H-saturated ZrV(O) alloy show a resistance against sputtering during their bombardment by high-energy particles in vacuum.

Another such method is taught in U.S. Pat. No. 5,961,750, issued to Boffito, et al., for the use of nonevaporable getter (NEG) alloys for maintaining vacuum in thermal insulations, for e.g. inside evacuated cavities of thermos bottles, Dewar bottles, or pipes for transporting petroleum in Arctic regions. These NEG alloys primarily contain Zr, Co, and a third component selected from rare earth metals and mixtures thereof

Yet another example is U.S. Pat. No. 4,668,424, issued to Sandrock., for the description of a reusable hydrogen getter comprising of a mixture of zirconium, nickel, and mischmetal. Briefly, this patent teaches processes for preparing these getters, improving their gettering capacity, and methods for regenerating them. In one embodiment, this invention describes hydrogen gettering alloys capable of gettering hydrogen to pressures below 0.01 torr at temperatures as low as 18-20° C., i.e. at room temperatures. In further embodiments this patent describes hydrogen getters that can be readily activated at room temperatures and low hydrogen pressures and getters that can be readily reactivated and reused.

Yet another example is U.S. Pat. No. 5,041,147, issued to, Knize and Cecchi, teaches a method and an apparatus for the separation of hydrogen isotopes, from the gaseous products originating from nuclear fusion reactors. In one embodiment, the invention is described as a bulk getter system comprising of zirconium and aluminum alloy to separately recover and reuse deuterium and tritium.

### SUMMARY OF THE INVENTION

In one embodiment the present invention is an electrically controlled getter device that comprises a substrate comprising a metal alloy, with the substrate is in fluid communication with one or more pumps and the flow of a fluid in contact with the metal alloy is controlled by one or more microvalves positioned between a source of a fluid and the metal alloy. Gaseous materials are adsorbed and selectively released on application of an electrical charge to the metal alloy. The device of the present invention can be typically incorporated within a mass spectrometer, a small SEM, a vacuum pump, or similar portable devices. In one aspect, a mass spectrometer incorporating the present invention is a quadrupole ion trap mass spectrometer comprised of either hyperbolic or cylindrical ring electrodes. In a further aspect, the one or more pumps of the present invention are coated with a material that comprises a metal alloy, which may be selected from zirconium, vanadium, iron, cobalt, aluminum, rare earth metals, lanthanum, cerium, praseodymium, neodymium, or combinations thereof. In another aspect, the coating material of the present invention reacts irreversibly with oxygen, carbon-dioxide, water vapor, and nitrogen, and reacts reversibly and adsorbs hydrogen and inert gases.

In another embodiment the present invention describes a method for analysis of a sample, comprising the steps of: transforming one or more molecules of the sample to one or more ionized particles; sorting the one or more ionized particles by the application of an electric field, a magnetic field or both; trapping the one or more ionized particles in an ion trap, wherein the ion trap comprises a substrate coated with a metal alloy, wherein the substrate is in fluid communication with one or more pumps and a flow of a fluid in contact with the metal alloy is controlled by one or more microvalves positioned between a source of a fluid and the metal alloy, wherein the metal alloy adsorbs gaseous materials upon the application of an electrical charge to the metal alloy and selectively releases certain gases; ejecting the one or more ionized particles from the ion trap; and detecting a total ionic current from the one or more ionized particle.

In one aspect, the present invention describes a method for analysis of a sample that comprises one or more organic molecules, inorganic molecules, biomolecules, proteins, peptides, pollutants, environmental contaminants, liquid explosives, bioterrorist agents, or combinations thereof. In a further aspect the sample is transformed to one or more ionic particles by a chemical or thermal ionization method. In another aspect, the ion trap comprises a quadrupole comprising of hyperbolic or cylindrical ring electrodes and is pressurized with a gas. In yet another aspect the ion trap comprises a gaseous material to buffer the ions.

In another aspect, the one or more pumps are coated with a material comprising a metal alloy selected from zirconium, vanadium, iron, cobalt, aluminum, rare earth metals, lanthanum, cerium, praseodymium, neodymium, or combinations thereof. In yet another aspect the coating material reacts irreversibly with oxygen, carbon-dioxide, water vapor, and nitrogen and reversibly with hydrogen and inert gases. In a further aspect of the present invention, the material adsorbs hydrogen gas that is then used to pressurize the ion trap and to buffer the ions.

### BRIEF DESCRIPTION OF THE DRAWINGS

For a more complete understanding of the features and advantages of the present invention, reference is now made to the detailed description of the invention along with the accompanying figures and in which:

FIG. 1A is the schematic illustration of a single cylindrical ion trap (CIT).

FIG. 1B shows the applied voltage profile in a CIT.

FIG. 2A shows a cylindrical ion trap array template.

FIG. 2B is an expanded view of a microfabricated array of cylindrical ion traps.

FIG. 3 is a schematic of a cylindrical ion trap mass spectrometer.

FIG. 4 is a computer-aided design of an ion trap in a miniature mass spectrometer with three getters and a microvalve to release and control hydrogen content.

FIG. 5 is a computer-aided design of a miniature mass spectrometer showing the ion-trap with the getter assembly and the microvalves.

FIG. 6 is a logarithmic plot of the gettering rate (mL/sec) versus the quantity sorbed (mL/Torr) at 900° C. for 10 minutes studied for hydrogen, nitrogen, oxygen and carbon monoxide.

FIG. 7 is the mass spectrum using the present invention; and

FIG. 8 is the mass spectrum using the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

It is contemplated that any embodiment discussed in this specification can be implemented with respect to any method, kit, reagent, or composition of the invention, and vice versa. Furthermore, compositions of the invention can be used to achieve methods of the invention.

Research in the field of microsensors has provided a great impetus to the development of smaller instrument components. Among these developments, are included small, low power ion sources, such as field emitters, which produce a high electron current with minimal power requirement. Miniaturization of mass spectrometry applications has resulted from the development portable vacuum and turbo pumps. Research groups are active in the development of submillimeter ion trap, rectilinear ion trap, micron sized ion trap arrays, and mini time-of-flight (TOF) detectors. Ion detection has also been made microscale with small channeltron and microchannel plate (MCP) detectors from DeTech and Burle.

Researchers have been successful in developing sub-mm cylindrical ion-traps (Moxom, et al., and Moxom et al.), small rectilinear traps (Sokol, et al.), toroidal ion trap (Lammert et al.), miniature TOF mass spectrometer (Brinckerhoff, et al.). Research efforts are also underway in trying to miniaturize the rotating-field mass spectrometers and small sectors, however these efforts have met with only limited success to date.

Resolution and ion attenuation are the two major challenges facing current miniature devices. Decreased ion attenuation is directly related to the small device size. With smaller devices space-charge and surface-charge effects increase, decreasing the number of ions trapped or guided. For ion-traps the maximum number of ions (Nₘₐₓ) stored is directly proportional to the depth of the pseudo-potential well (D_{z}) (Dawson), as shown in equation 1 below:

Nₘₐₓ ∝ D_{z} (1)

A typical z=1 cm trap will hold 10⁶-10⁷ ions. As the trap gets smaller by an order of magnitude, so does the ion count. A z=1 mm trap will hold approximately 10⁵ ions. One way to overcome this deficit is to array the ion traps to regain ion count. If this is done, alignment becomes critical due to ion ejection from multiple traps.

Resolution (m/Δm), increases with increasing time. Resolution and time are related by equations 2, 3, and 4 for TOF, linear quad (LQ) and QIT mass spectrometers, respectively:

$$\begin{matrix}{R}_{TOF} ∝ \frac{L}{{E}_{z}} & ( 2 ) \\ {R}_{LQ} ∝ \frac{1}{{E}_{z}} {( \frac{L}{π r} )}^{2} & ( 3 ) \\ {R}_{QIT} ∝ {D}_{z} t & ( 4 )\end{matrix}$$

TOF and LQ mass spectrometers are the most difficult to miniaturize without compromising the resolution, as the resolution is length dependent. Use of a reflectron or passing the ion back and forth are approaches that can be used to increase the time of flight within a more confined space. QIT and cylindrical ion traps can have increased resolution within a miniature device. Trapping time can be increased to increase resolution at the expense of signal attenuation.

With the increasing use of miniature mass spectrometers, small SEMs, chemical sensors and vacuum devices, in analytical research, among first responders, military, environmentalists, TSA, and field researchers there is a growing need to run these devices without carrying high pressure gas cylinders to pressurize and maintain vacuum conditions required to run these devices.

Hydrogen gas is typically used regulate pressures and act as a buffer to thermalize the trapped ions in these devices. In addition to maintaining the vacuum, the buffer gas at pressures of approximately 1×10⁻⁴ torr is needed to keep the ions from escaping the trap. LQ's and ion mobility spectrometers also require pressure regulation at vacuum.

The present invention obviates the use of cumbersome high-pressure gas cylinders to operate miniature mass spectrometers and other portable vacuum devices. The present invention makes use of getters saturated with hydrogen to regulate the pressure in mass spectrometers and also utilizes the gas for buffering the ions. These getters (i.e. titanium and zirconium) have been used as pumps and hydrogen sources previously but never to regulate pressures in portable vacuum devices requiring regulated hydrogen supply. The getters are current controlled to produce the necessary hydrogen number density, with a microvalve implemented between the chambers to release and control hydrogen content.

The following diagrams illustrate the technology invented and subsequent explanation of each component of the invention.

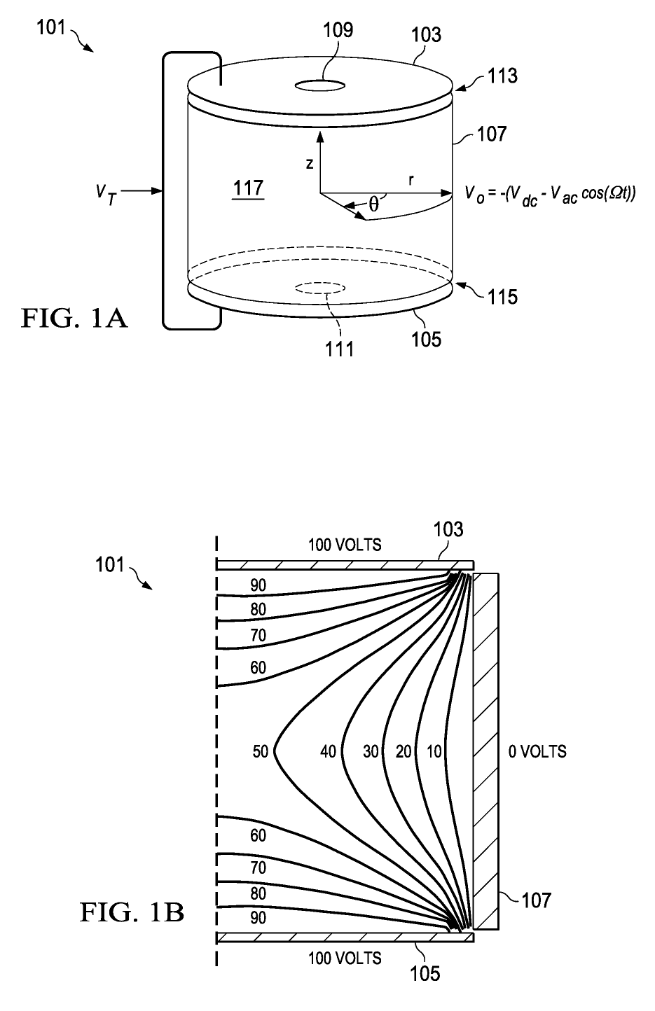

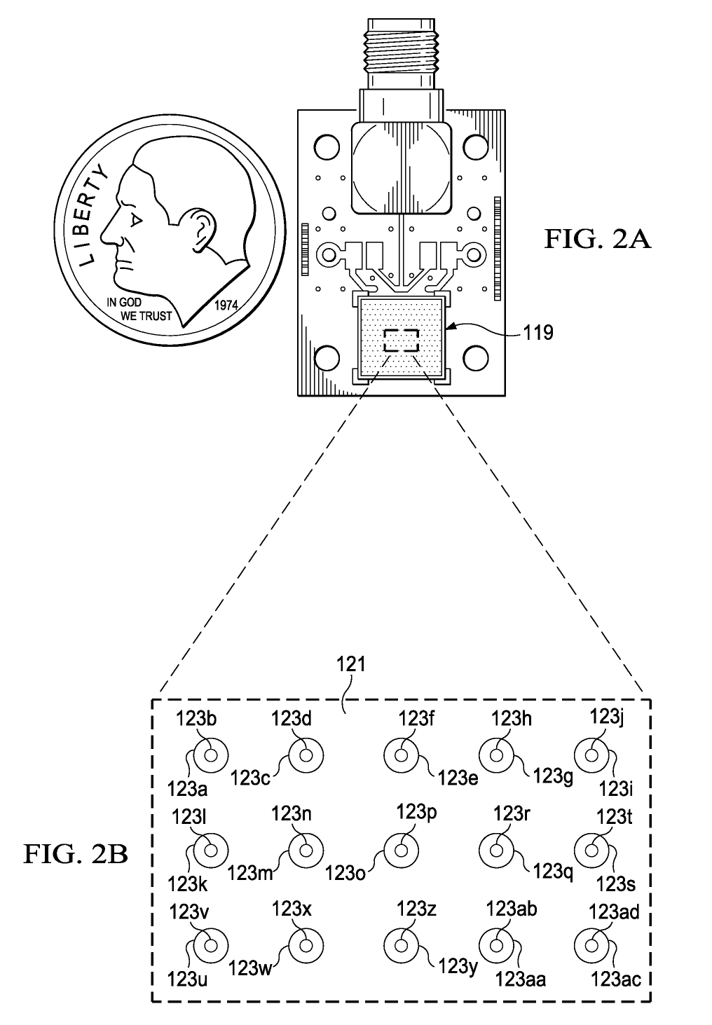

FIG. 1A is a schematic illustration of a single CIT 101. The ion trap 101 comprises a cylindrical ring electrode 107, and two endcap electrodes at the top and the bottom 103 and 105, respectively. 113 and 115 represents the dielectric spaces between the ring electrode 107 and the endcap electrodes 103 and 105, respectively. The ions are trapped in the space 117 between the end cap electrodes 103 and 105 and the ring electrode 107. Openings 109 and 111 are made in the top and bottom electrodes 103 and 105, for injection of the ionized sample and for the ejection of the ions from the space 117. The CIT 101 is rotationally symmetric about the z-axis. r is the inner radius of the ring electrode 107. A power source (not shown in the figure) can be used to provide dc and rf voltage to the CIT 101. V_{T} represents the voltage between the top and the bottom electrodes 103 and 105, and Vₒ represents the voltage applied to the ring electrode 107.

FIG. 1B shows the voltage profile across a section of a CIT 101. Voltages across the endcap electrodes 103 and 105 decrease axially towards the center of the CIT. Voltages across the ring electrode 107 increase radially towards the center of the CIT 101.

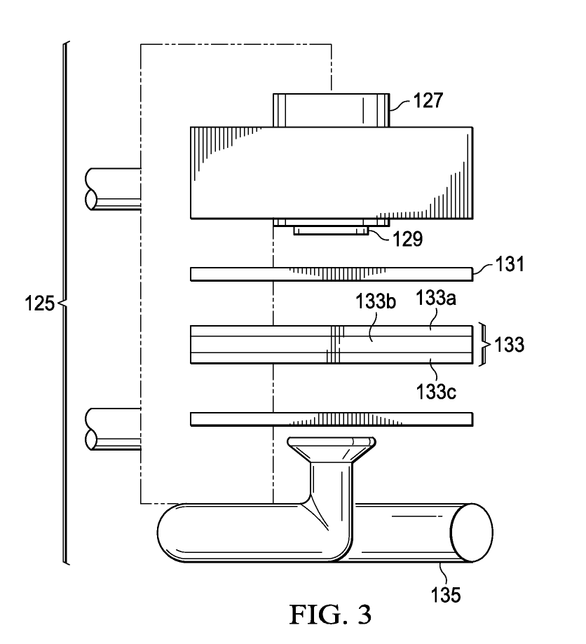

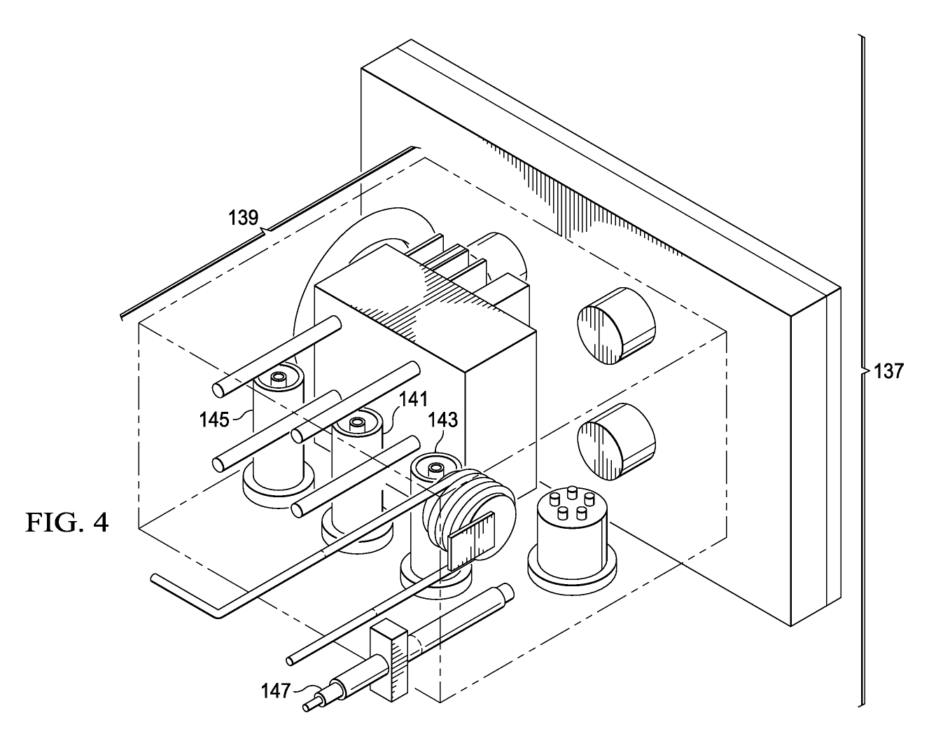

FIG. 2A shows a template 119 on which is present an array of cylindrical ion traps. FIG. 2B is an expanded view of a microfabricated array of cylindrical ion traps. The supporting template or metallic plate 121, comprises of cylindrical holes 123a, 123c, 123e, 123g, 123i, 123k, 123m, 123o, 123q, 123s, 123u, 123w, 123y, 123aa, and 123ac. Extraction holes 123b, 123d, 123f, 123h, 123j, 123l, 123n, 123p, 123r, 123t, 123v, 123x, 123z, 123ab, and 123ad, are present on the cylindrical axis of each of the cylindrical holes listed above.

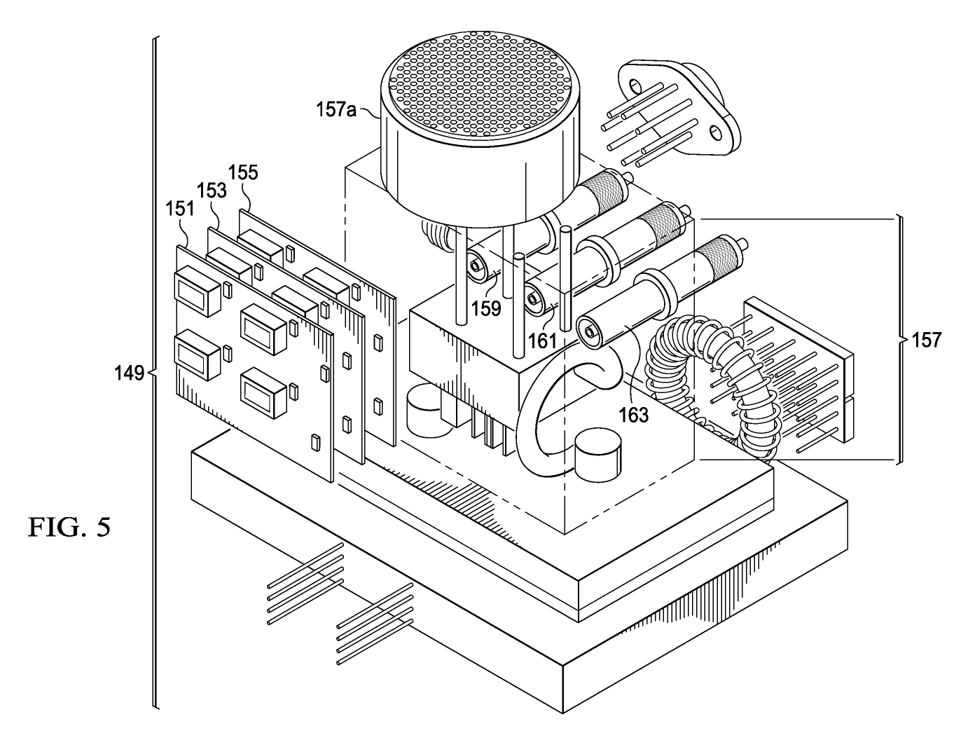

FIG. 3 is a schematic of a CIT mass spectrometer 125. The CIT mass spectrometer 125, comprises of a MACOR® sleeve 127, and ionizer 129 to ionize the sample. A voltage can be applied to the tuning lens 131, to regulate and direct the passage of the generated ions to the ion trap 133. The ion trap 133, comprises of a ring electrode 133b and two end cap electrodes 133a and 133c. A Channeltron® device 135 is used to detect the ions ejected from the ion trap and measures the total ion current.

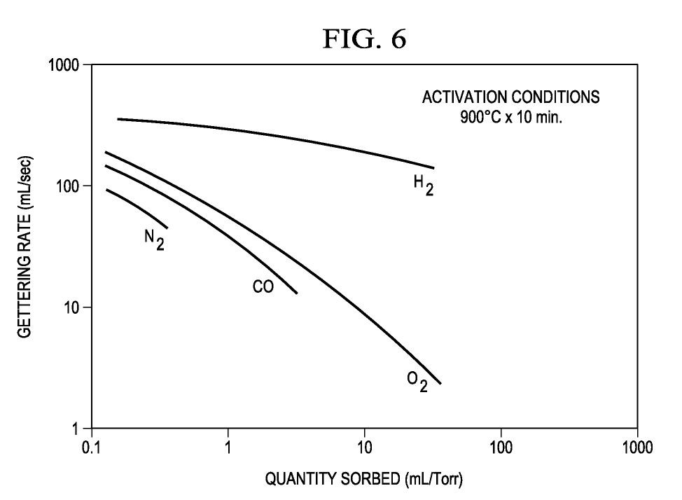

FIG. 4 is a computer aided design of the interior of an ion trap 139 of a CIT mass spectrometer 137. Ion trap 137 comprises three gettered pumps 139, 141, and 143 for sorbing and releasing hydrogen gas to maintain the pressure and as a buffer to thermalize the ions. Ion trap 137 also has a microvalve 145 to release and control hydrogen content inside the ion trap 139.

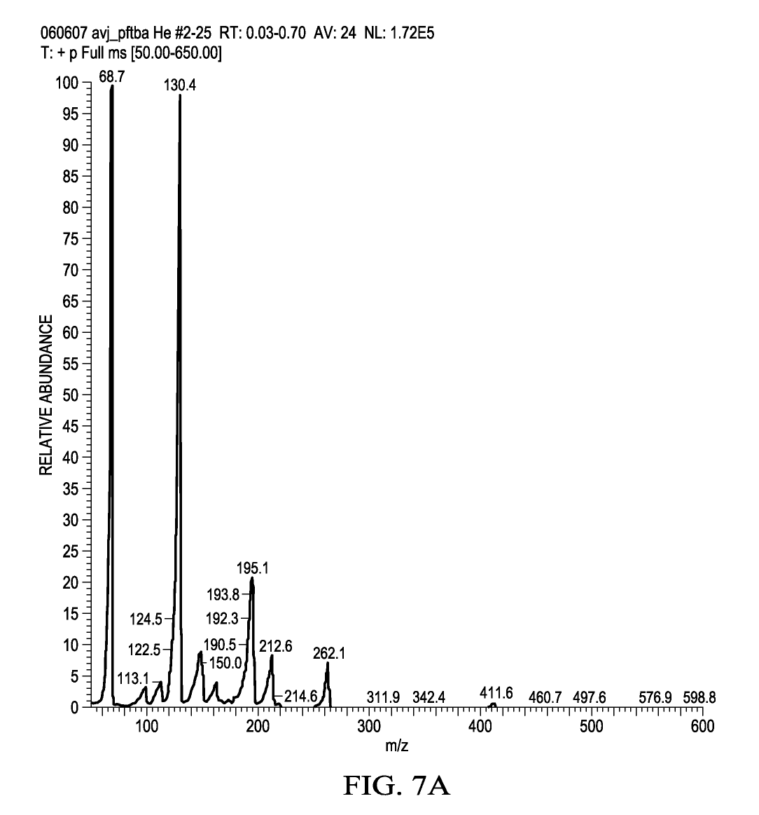

FIG. 5 is a computer aided cross-sectional design of a CIT mass spectrometer 149, comprising a MACOR® sleeve 151, an ionizer 153, and a tuning lens 155. The ion trap chamber 157 comprises a microfabricated cylindrical ion trap array 157a, and three gettered pumps 159, 161, and 163 for sorbing and releasing hydrogen gas to maintain the pressure and as a buffer to thermalize the ions.

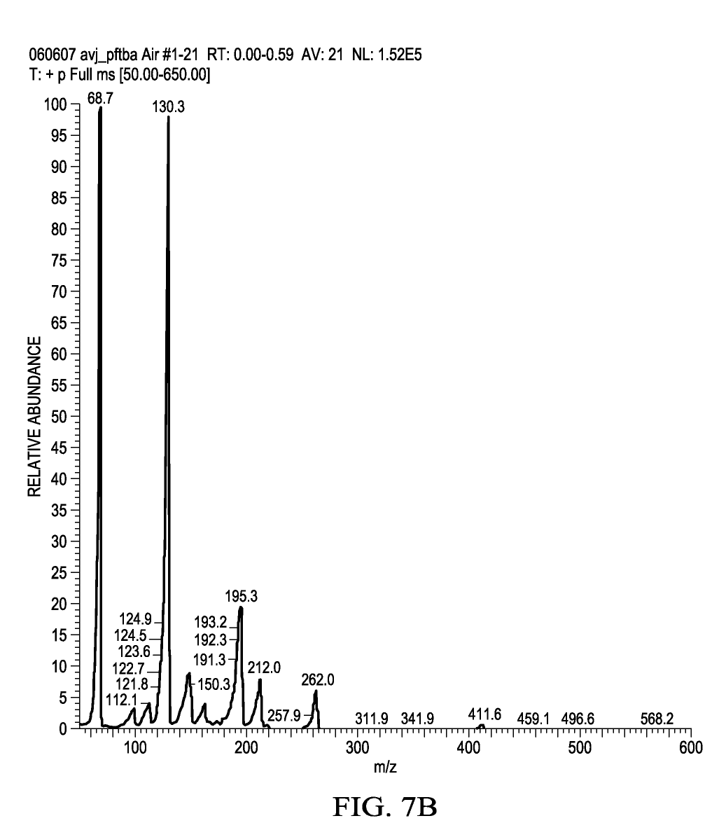

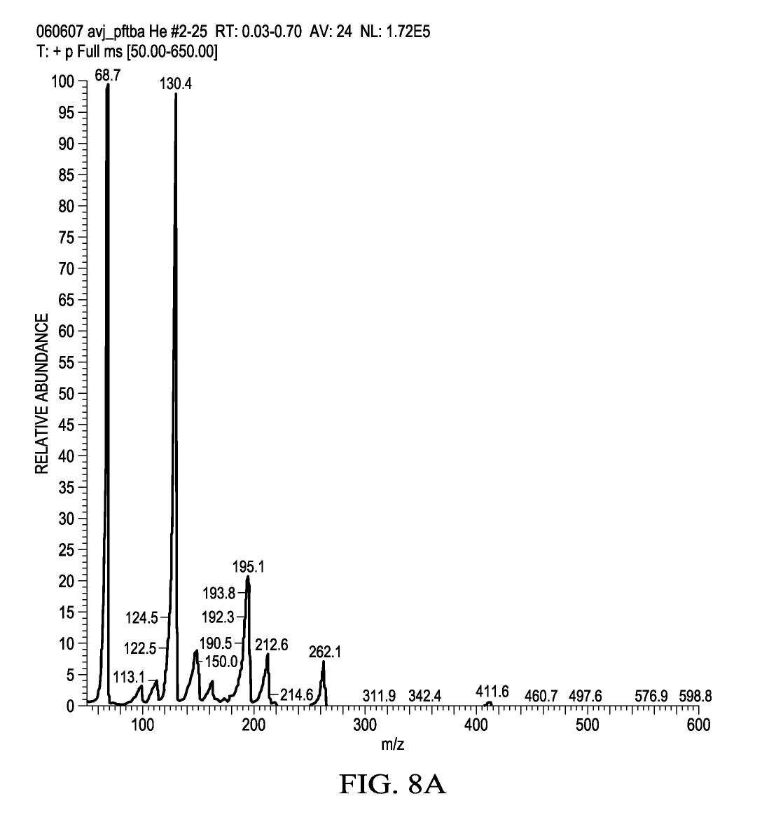

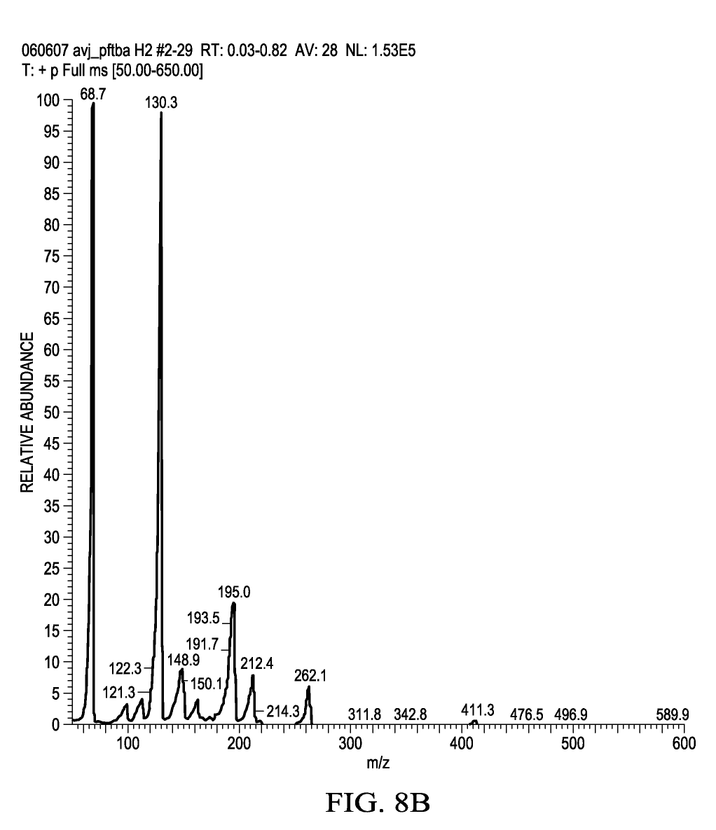

FIG. 6 shows the relationship between the gettering rate (mL/sec) versus the quantity sorbed (mL/Torr) at 900° C. for 10 minutes studied for hydrogen, nitrogen, oxygen and carbon monoxide. The logarithmic plot indicates a decrease in the gettering rate with the increase in the amount of the sorbed gas. The decrease in rate is greater for N₂, O₂, and CO when compared to H₂, thus indicating the effectiveness of the gettering system of the present invention for sorbing H₂. FIGS. 7 and 8 show mass spectra obtained using the present invention

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

Lototsky, M. V.; Yartys, V. A.; Klochko, Ye. V.; Starovoitov, R. I.; Azhazha, V. M.; V'yugov, P. N. Journal of Alloy and Compounds, 404-406 (2005) 724.

Rho, C. B.; Como, A. C.; Milan, S. T. Nonevaporable Getter Alloys. U.S. Pat. No. 5,961,750.

Sandrock, G. D. Low Temperature Reusable Hydrogen Getter. U.S. Pat. No. 4,668,424.

Knize, R. J.; Cecchi, J. L. Hydrogen Isotope Separation Utilizing Bulk Getters. U.S. Pat. No. 5,041,147.

Moxom, J.; Reilly, P. T. A.; Whitten, W. B.; Ramsey, J. M. Anal. Chem. 75 (2003) 3739.

Moxom, J.; Reilly, P. T. A.; Whitten, W. B.; Ramsey, J. M. Rapid Commun. Mass Spectrom. 16 (2002) 755.

Sokol, E.; Edwards, K. E.; Qian, K.; Cooks, R. G. Analyst. 133 (2008) 1064.

Lammert, S. A.; Rockwood, A. A.; Wang, M.; Lee, M. L. J. Am. Mass Spectrom. 17 (2006) 916.

Brickerhoff, W. B.; Cornish, T. J.; McEntire, R. W.; Cheng, A. F.; Benson, R. C. Acta Astronautica 52 (2003) 397.

Dawson, P. H. Quadrupole Mass Spectrometry and its Applications. American Institute of Physics Press, New York, 1995.

What is claimed is:

1. A electrically controlled getter device comprising:
a substrate comprising a metal alloy, wherein the substrate is in fluid communication with one or more pumps and a flow of a fluid in contact with the metal alloy is controlled by one or more microvalves positioned between a source of a fluid and the metal alloy, wherein the metal alloy adsorbs gaseous materials upon the application of an electrical charge to the metal alloy and selectively releases certain gases.

2. The device of claim 1, wherein the said device is enclosed within a mass spectrometer, small SEMs, vacuum pumps, and other portable devices.

3. The device of claim 2, wherein the mass spectrometer is a quadrupole ion trap mass spectrometer.

4. The device of claim 3, wherein said quadrupole comprises hyperbolic or cylindrical ring electrodes.

5. The device of claim 1, wherein the one or more pumps are coated with a material comprising a metal alloy.

6. The device of claim 1, wherein the metal alloy comprises zirconium, vanadium, iron, cobalt, aluminum, rare earth metals, lanthanum, cerium, praseodymium, neodymium, and combinations thereof.

7. The device of claim 1, wherein the metal alloy reacts irreversibly with oxygen, carbon-dioxide, water vapor, and nitrogen.

8. The device of claim 1, wherein the metal alloy reacts reversibly with hydrogen and inert gases.

9. The device of claim 1, wherein the metal alloy adsorbs to hydrogen gas.

10. A method for analysis of a sample, comprising the steps of:
transforming one or more molecules of the sample to form one or more ionized particles;
sorting the one or more ionized particles by the application of an electric field, a magnetic field or both; trapping the one or more ionized particles in an ion trap, wherein the ion trap comprises a substrate comprising a metal alloy, wherein the substrate is in fluid communication with one or more pumps and a flow of a fluid in contact with the metal alloy is controlled by one or more microvalves positioned between a source of a fluid and the metal alloy, wherein the metal alloy adsorbs gaseous materials upon the application of an electrical charge to the metal alloy and selectively releases certain gases;
ejecting the one or more ionized particles from the ion trap; and
detecting a total ionic current from the one or more ionized particles.

11. The method of claim 10, wherein the sample comprises one or more organic molecules, inorganic molecules, biomolecules, proteins, peptides, pollutants, environmental contaminants, liquid explosives, bioterrorist agents, or combinations thereof.

12. The method of claim 10, wherein the sample is transformed to one or more ionic particles by a chemical or thermal ionization method.

13. The method of claim 10, wherein the ion trap comprises a quadrupole.

14. The method of claim 10, wherein the ion trap is pressurized with a gas.

15. The method of claim 10, wherein the ion trap comprises a gaseous material to buffer the ions.

16. The method of claim 13, wherein the quadrupole comprises hyperbolic or cylindrical ring electrodes.

17. The method of claim 10, wherein the one or more pumps are coated with a material comprising a metal alloy.

18. The method of claim 10, wherein the metal alloy comprises zirconium, vanadium, iron, cobalt, aluminum, rare earth metals, lanthanum, cerium, praseodymium, neodymium, and combinations thereof.

19. The method of claim 10, wherein the metal alloy reacts irreversibly with oxygen, carbon-dioxide, water vapor, and nitrogen.

20. The method of claim 10, wherein the metal alloy reacts reversibly with hydrogen and inert gases.

21. The method of claim 10, wherein the metal alloy adsorbs hydrogen.

22. The method of claim 14, wherein the gas used to pressurize the ion trap is hydrogen.

23. The method of claim 15, wherein the gaseous material used to buffer the ions is hydrogen.
